(19) United States
(12) Patent Application Publication
(10) Pub. No.: US 2017/0227731 A1
(43) Pub. Date: Aug. 10, 2017

(54) IMAGING APPARATUS

(71) Applicant: Microsoft Technology Licensing, LLC, Redmond, WA (US)

(72) Inventor: Marko Eromäki, Tampere (FI)

(21) Appl. No.: 15/041,011

(22) Filed: Feb. 10, 2016

(51) Int. Cl. G02B 7/09; H02N 2/02; G03B 5/06; H02K 41/035; G02B 27/64; G03B 13/36

(52) U.S. Cl. CPC G02B 7/09; G02B 27/646; G03B 13/36; G03B 5/06; H02K 41/0354; H02N 2/02; G03B 2205/0023; G03B 2205/0069

(57) ABSTRACT

The imaging apparatus comprises a retractable structure with active and inactive positions. In the inactive position the lens group and the lens group actuator reside close to an image sensor. An activating actuator moves the lens group and at least one lens group actuator between active and inactive positions. The activating actuator comprises a movable ferromagnetic element and a fixed electromagnetic element. When an electric current is applied to the electromagnetic element, the ferromagnetic element moves to a predefined position. The retractable lens movement is in one embodiment bistable, for example a piece of ferromagnetic material holding the retractable element in place.

### BACKGROUND

Digital cameras usually comprise a lens and a sensor for capturing an image by capturing light and converting it into electrical signals. Mobile electronic devices such as smart phones are usually equipped with an imaging apparatus, a camera. The imaging quality of the mobile electronic devices may be improved by optical image stabilization or autofocus. A current trend in designing mobile electronic devices aims for thin devices, wherein the form factor benefits from thin imaging apparatus to be housed inside the mobile electronic device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The imaging apparatus comprises a retractable structure with active and inactive positions. An outermost lens group and a lens group actuator are movable along an optical axis. Examples of a lens group actuator are an autofocus actuator or an optical image stabilizer. In the inactive position the lens group and the lens group actuator reside close to an image sensor. The lens group actuator is positioned on the same level as the image sensor.

An activating actuator moves the lens group and at least one lens group actuator between active and inactive positions. The activating actuator comprises a movable ferromagnetic element and a fixed electromagnetic element. When an electric current is applied to the electromagnetic element, the ferromagnetic element moves to a predefined position. The retractable lens movement is in one embodiment bistable, for example a piece of ferromagnetic material holding the retractable element in place. The structure allows imaging apparatuses with better optical characteristics to be implemented for example in very thin devices. Devices with various form factors benefit from a smaller imaging apparatus as there is more room to implement other features in the device.

Many of the attendant features will be more readily appreciated as they become better understood by reference to the following detailed description considered in connection with the accompanying drawings. The embodiments described below are not limited to implementations which solve any or all of the disadvantages of known imaging apparatuses integrated in hand-held devices.

### DESCRIPTION OF THE DRAWINGS

The present description will be better understood from the following detailed description read in light of the accompanying drawings, wherein:

FIG. 1a shows one embodiment of an electronic device incorporating two imaging apparatuses;

FIG. 1b shows the rear side of the embodiment with the imaging apparatus in an active position;

FIG. 2a shows one embodiment of an electronic device incorporating one imaging apparatus;

FIG. 2b shows the rear side of the embodiment with the imaging apparatus in an active position;

FIG. 3a is a simplified cross-sectional view of one embodiment of an imaging apparatus in an active position;

FIG. 3b is a simplified cross-sectional view of the embodiment in an inactive position;

FIG. 4a is a simplified cross-sectional view of one embodiment of an imaging apparatus in an active position having a movable image sensor;

FIG. 4b is a simplified cross-sectional view of the embodiment in an inactive position;

FIG. 5 is a simplified cross-sectional view of one embodiment of an imaging apparatus having a curved image sensor;

FIG. 6 is a simplified cross-sectional view of one embodiment of an actuator;

FIG. 7a is a simplified cross-sectional view of one embodiment having the retractable lens in an active position;

FIG. 7b is a simplified cross-sectional view of the embodiment having the retractable lens in the inactive position;

FIG. 8a is a simplified cross-sectional view of one embodiment having the retractable lens in an active position;

FIG. 8b is a simplified cross-sectional view of the embodiment having the retractable lens in the inactive position; and

FIG. 9a is a simplified cross-sectional view of one embodiment wherein the actuator comprises a slider having the retractable lens in an inactive position;

FIG. 9b is a simplified cross-sectional view of one embodiment wherein the actuator comprises a slider having the retractable lens in an active position.

Like reference numerals are used to designate like parts in the accompanying drawings.

### DETAILED DESCRIPTION

The detailed description provided below in connection with the appended drawings is intended as a description of the present embodiments and is not intended to represent the only forms in which the present embodiments may be constructed or utilized. However, the same or equivalent functions and sequences may be accomplished by different embodiments.

Although the present embodiments are described and illustrated herein as being implemented in a smartphone, the device described is provided as an example and not a limitation. As those skilled in the art will appreciate, the present embodiments are suitable for application in a variety of different types of mobile and/or hand-held apparatuses, e.g. in tablets, laptops, digital cameras or gaming consoles.

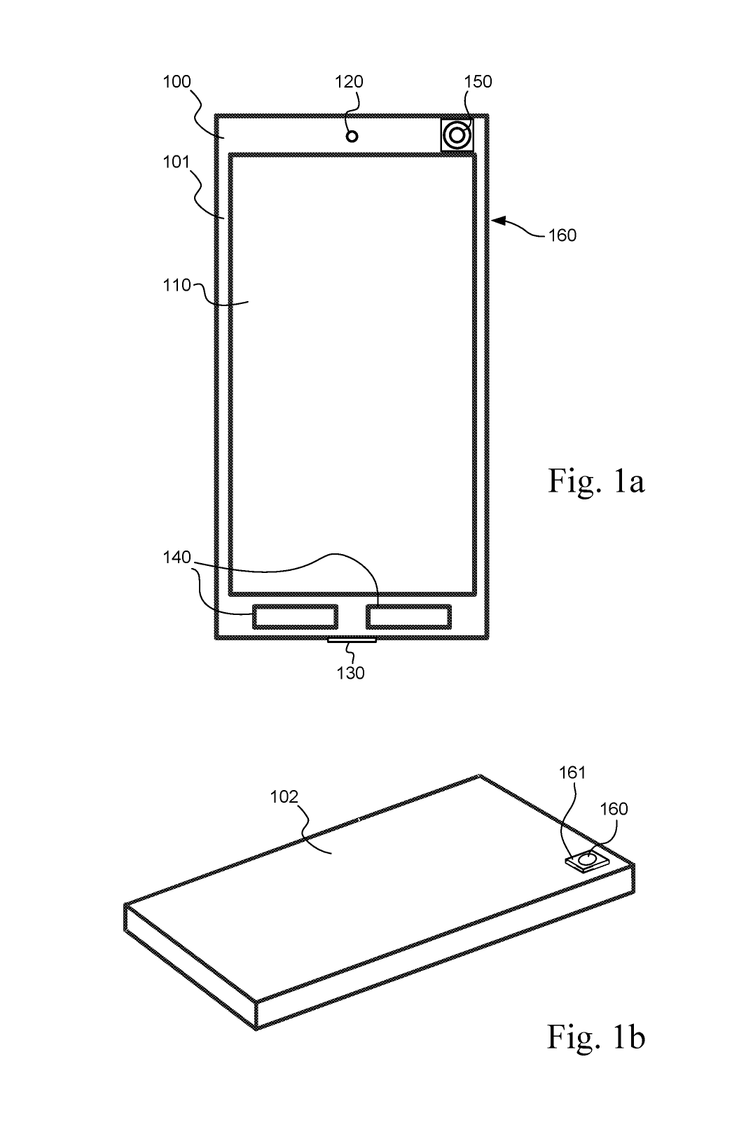

FIG. 1a shows a front side of one example of an electronic device incorporating an imaging apparatus, wherein one embodiment of the electronic device is a smartphone. The electronic device comprises a body 100 comprising a display 110, a speaker 120, a microphone 130 and keys 140. The electronic device comprises an imaging apparatus 150, a camera on one surface. The electronic device may comprise two or more cameras, for example a front camera 150 on the front surface and another imaging apparatus, a rear camera 160 on the rear side. FIG. 1b shows the rear side of the electronic device, wherein the rear camera 160 resides on a retractable element 161. In one example the retractable element provides a protective casing for at least one lens actuator and a first lens group. The retractable element 161 is shown in an active position, wherein at least one lens and at least one actuator are moved apart from the image sensor group along an optical axis. The optical axis is a line along which there is some degree of rotational symmetry in an optical system. The optical axis is an imaginary line that defines a path along which light propagates through the system. In an inactive position the retractable element 161 may be flush with the rear surface. According to an embodiment, a transparent front surface 101 made of glass covers the display and the lens of the front camera 150. The rear surface 102 is opaque and is, for example, made of plastic or metal. Having a retractable element protruding from a glass surface may require additional edges and sharp corners to be manufactured to the glass surface, therefore implementing the retractable element on a surface made of plastic or metal may be more economical.

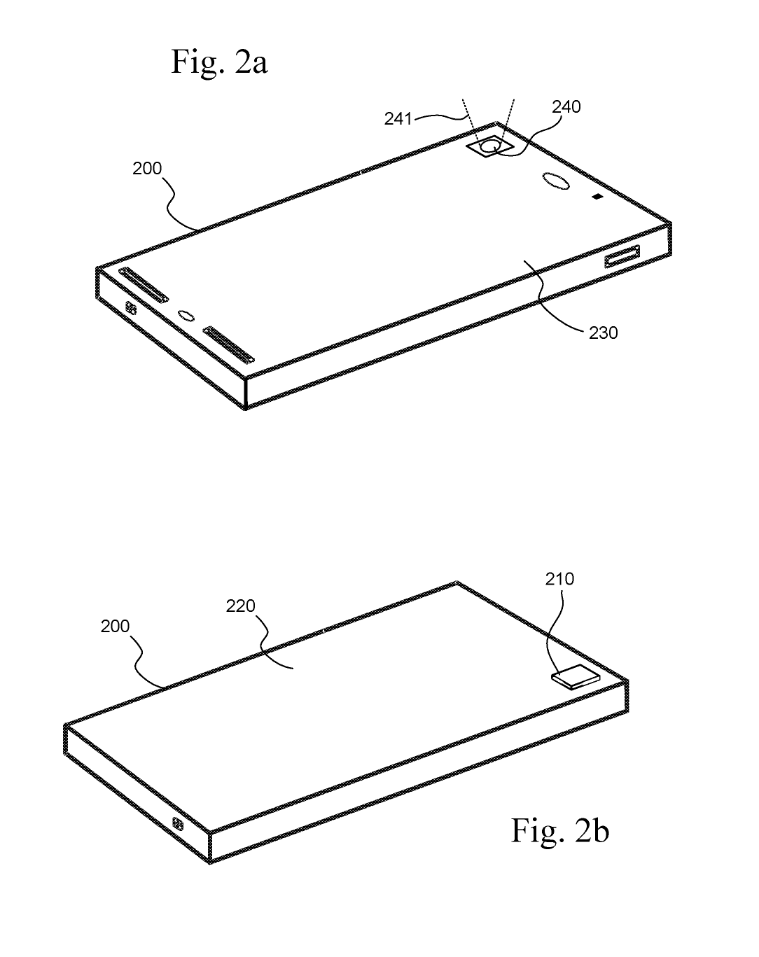

FIGS. 2a and 2b illustrate a device 200 having a movable sensor group inside the retractable element 210, according to an embodiment. The retractable element 210 protrudes from the rear surface 220. The front surface 230 is covered with transparent material such as glass. An imaging device 240, for example a camera, has an optical field of vision 241 through the flush front surface 230. The retractable element 210 protrudes from the rear surface 220 in the active position, providing additional distance between the sensor group and the first lens group. In an embodiment a portion of the transparent front surface 230 is comprised in the first lens group. As illustrated in the previous examples, the travel of the retractable element may be few millimeters to allow the active position.

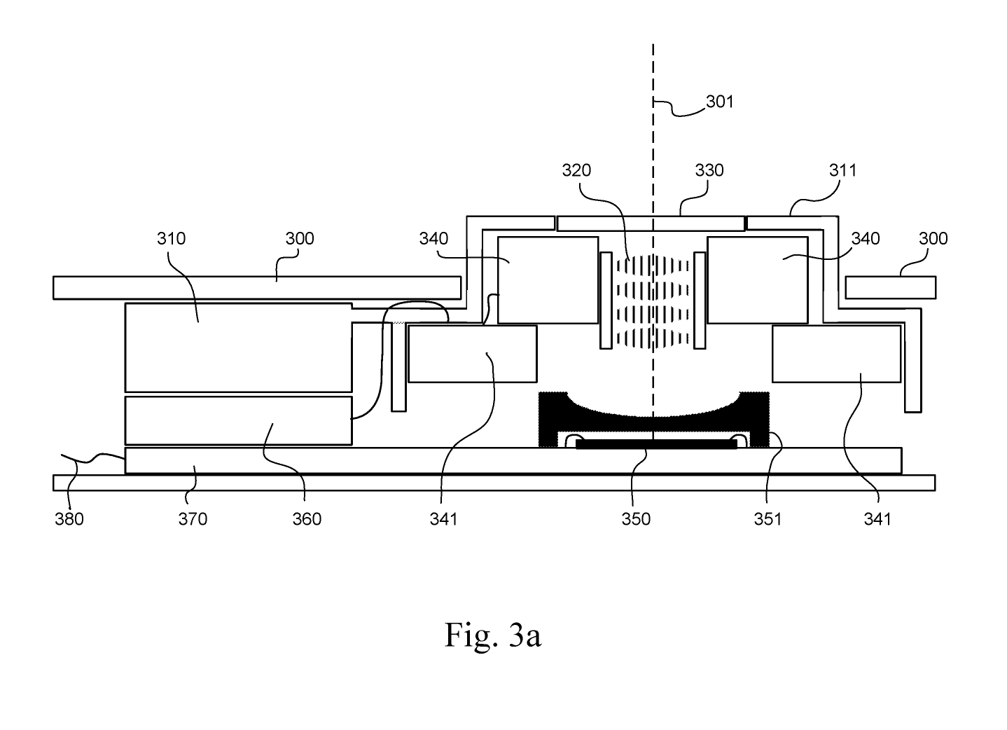

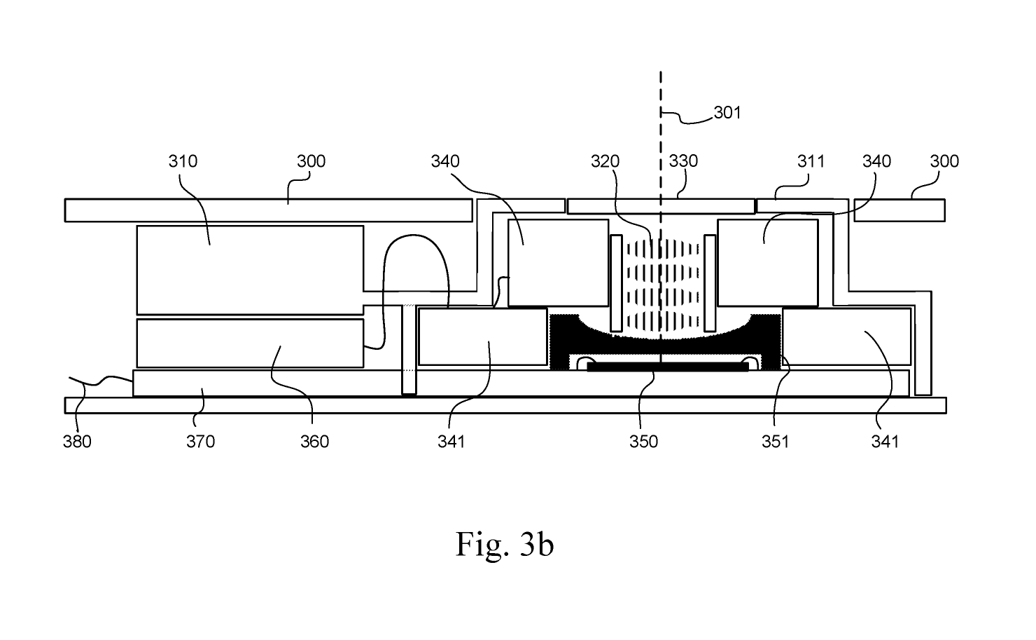

FIG. 3a is a simplified cross-sectional view of the imaging apparatus implemented in the electronic device in the active position. A first lens group 320 is positioned on the optical axis 301, wherein the first lens group 320 comprises the lens through which the light travels to the image sensor group 350. The first lens group 320 may comprise only one lens or it may be a combination of several lenses. In an embodiment, a window 330 on the retractable element 311 is a lens forming a part of the first lens group 320. The window 330 is not moved by a lens group actuator. In an embodiment, the first lens group 320 is a lens barrel, wherein the lenses may be fixed in relation to each other or they may be moved in order to enable various optical characteristics. An autofocus actuator 340 is configured to move the first lens group 320 or at least one lens in the first lens group 320 in order to reach a sharp focus on the image plane and on the image sensor 350. In an embodiment, the autofocus actuator is configured to alter the optical zoom factor. In an embodiment, the optical zoom factor is altered by an actuator configured inside the lens barrel. The autofocus actuator 340 is an example of a lens group actuator. The extended position allows movement for the lens group actuators 340, 341.

An optical image stabilizer 341 is configured to move the first lens group 320—in an embodiment, the optical image stabilizer 341 is configured to move the autofocus actuator 340 together with the first lens group 320. The optical image stabilizer 341 is an example of a lens group actuator. In an embodiment, the optical image stabilizer 341 is attached to the first lens group or to the lens barrel; whereas the autofocus actuator 340 is configured to move the image stabilizer 341 and the first lens group 320. In an embodiment, the autofocus actuator 340 is electromechanically connected to the optical image stabilizer 341, under the autofocus actuator 340 on the component stack.

According to an embodiment, the retractable element 311 suspends the structure of the at least one lens group actuator 340, 341 and at least portion of the first lens group 320. The retractable element 311 may comprise a frame that enables attaching the first lens group 320 or the at least one lens group actuator 340, 341 to the retractable element 311. In an embodiment, the retractable element 311 is configured to move, for example, on a rail or similar structure that guides the movement.

An activating actuator 310 is configured to move the first lens group 320 along the optical axis 301 between the active and inactive positions. The activating actuator 310 is configured to adjust the distance between at least one lens group actuator 340, 341 and the image sensor group 350. The first lens group 320 and the at least one lens group actuator 340, 341 have the active position and the inactive position in relation to the image sensor group 350 along the optical axis 301. In the active position the first lens group 320 and the at least one lens group actuator 340, 341 protrude from the device body 300 along the optical axis 301. In an embodiment, the actuator is a lifting mechanism that may comprise mechanical elements such as a lever that the user of the device applies in order to alter the distance between the first lens group 320 and the image sensor group 350 between active and inactive positions. In an embodiment, the lifting mechanism is a transmission system.

The image sensor group 350 resides on the optical axis, the image sensor 350 being on an image plane. The image sensor 350 is arranged on the optical axis to receive the image from the first lens group 320. A focal plane is a plane where object appears in focus. In an embodiment, the first lens group 320 is tilted in the direction that reduces the effect of detected shaking to achieve optical image stabilization. The tilted first lens group 320 causes the focal plane to tilt as well, wherein the focal plane and the image sensor 350 are not aligned. The image sensor 350 comprises, for example, a plurality of light sensing elements that measure the light captured by the light sensing elements to form an image of pixels. In an embodiment, the image sensor group 350 comprises the field flattening lens 351. The field flattening lens 351 corrects the focal plane projection error caused by tilting the first lens group 320. In an embodiment the image is stabilized by tilting and shifting the lens. In an embodiment the image is stabilized by shifting the lens. In an embodiment the image is stabilized by moving the image sensor or the image sensor group 350. The image sensor group may be defined by comprising an image sensor, an image sensor with one static lens or an image sensor with more than one static lenses.

The image sensor group 350 is mounted on the circuit board 370. The camera hardware 370 may comprise at least one of: a processor, a controller, a memory, or a sensor such as a gyroscope. A wiring, such a flex cable 380 may connect the imaging apparatus to the electronic device.

FIG. 3b shows the imaging apparatus in the inactive position. In the inactive position a portion of the one lens group actuator 341 is at the same level with the image sensor group 350, perpendicular to the optical axis 301. According to an embodiment, the first lens group 320 and the at least one lens group actuator 340, 341 are inside the device body 300. The lens is retracted, as the first lens group 320 is brought near the image sensor group 350. The lens group actuator lowered to the level of image sensor group 350 may be the autofocus actuator 340 or the optical image stabilizer 341, wherein the two lens group actuators may be stacked. In an embodiment, the lower lens group actuator is an autofocus actuator 340 or an optical image stabilizer 341.

The previous embodiment showed two-group optics, where the components are in the inactive position at a distance shorter than typical functional clearances. Examples of functional clearances are autofocus stroke, tolerance margins or the back focal length. The image sensor group remains static, whereas the first lens group is able to move vertically, along the optical axis. In an embodiment, the image sensor group and at least one lens group actuator are nested in the inactive position.

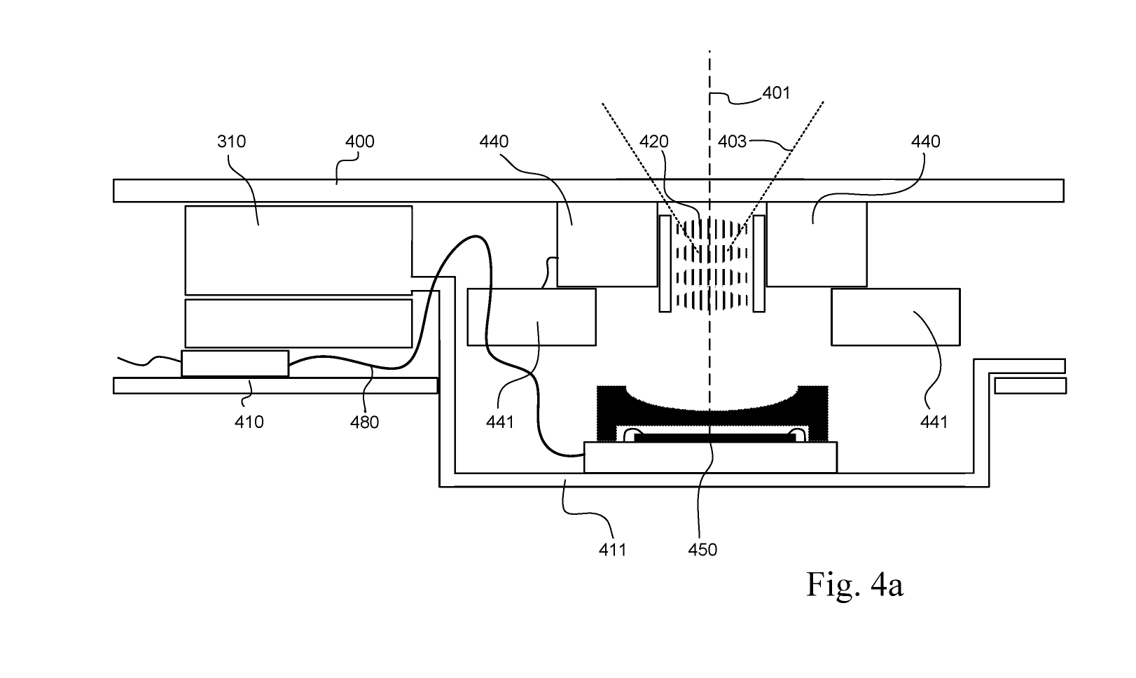

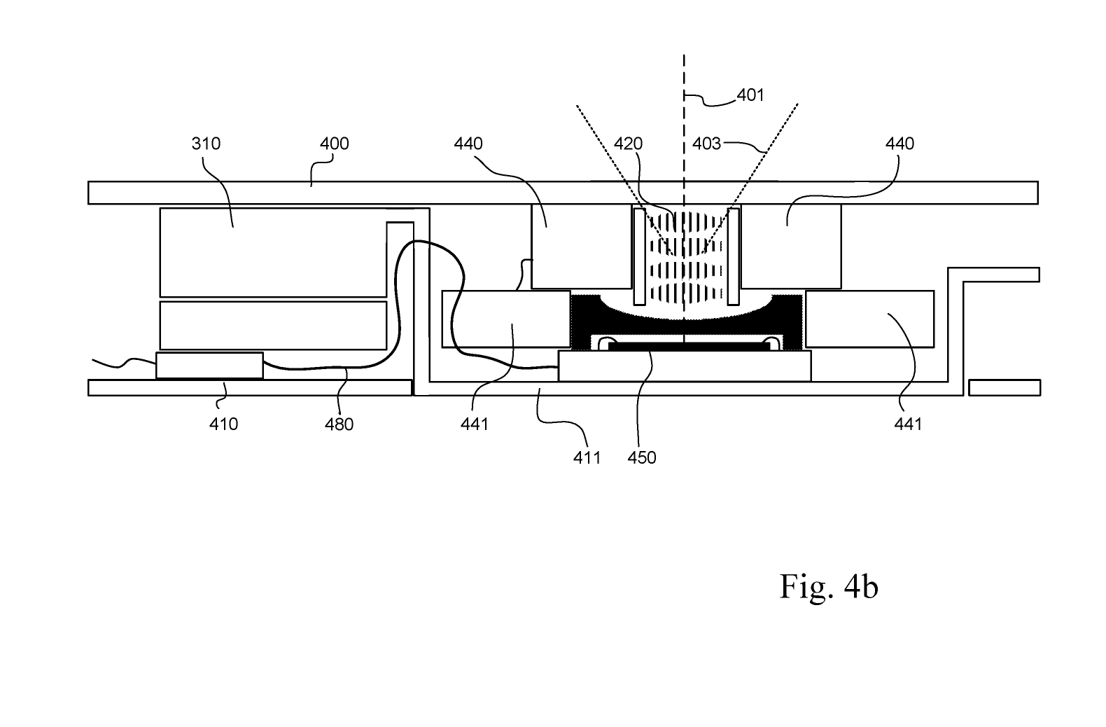

FIGS. 4a and 4b illustrate an embodiment, where the image sensor group 450 is movable in relation to the first lens group 420 and the device body. The device body comprises a transparent front surface 400 and an opaque rear surface 410. The first lens group 420 is attached inside the device body facing the transparent front surface 400. The first lens group may be attached to the device body by suspending from at least one lens group actuator 440, 441. The optical field of vision 403 of the imaging apparatus passes through the transparent surface 400. FIG. 4a shows the active position, wherein the image sensor group 450 protrudes from the device body along the optical axis 401. A retractable element 411 covers the imaging apparatus structure. The retractable element 411 protrudes from the device body causing a distance between the first lens group 420 and the image sensor group 450. The image sensor group 450 is attached to the retractable element 411. A wiring, such a flex cable 480 connects the image sensor group to the imaging apparatus.

In the inactive position the image sensor group 450 is inside the device body, as illustrated in FIG. 4b. In this example the device body is flush without any protrusions from the imaging apparatus. In an embodiment, the design may allow different shapes to be used in the context of retractable element.

The lens group actuator may be a voice coil actuator, a piezo actuator or a shape memory alloy actuator. In an embodiment, the actuator has a circular shape and the image sensor group fits inside the actuator perimeter. The lens group actuator may surround the image sensor group.

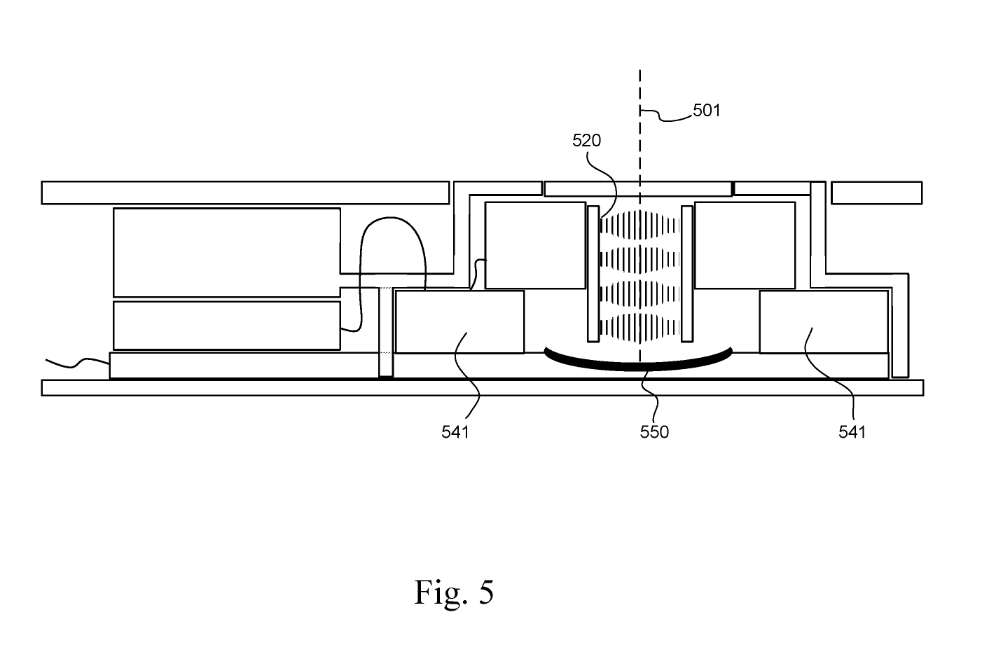

In an embodiment, the image sensor group comprises a curved image sensor 550, as illustrated in FIG. 5. The curved sensor 550 functions with the tiltable lens barrel 520 as the curvature of the sensor 550 follows the focal plane projection. In an embodiment, correcting the focal plane projection error with the field flattener lens is not required. The space required by the inactive position may be further reduced. The lens group actuator 541 may be lowered to the same plane as the curved sensor 550. The level is defined as being perpendicular to the optical axis 501. In an embodiment, a functional portion of the lens group actuator 541 is at the same level as the image sensor 550 or the image sensor group.

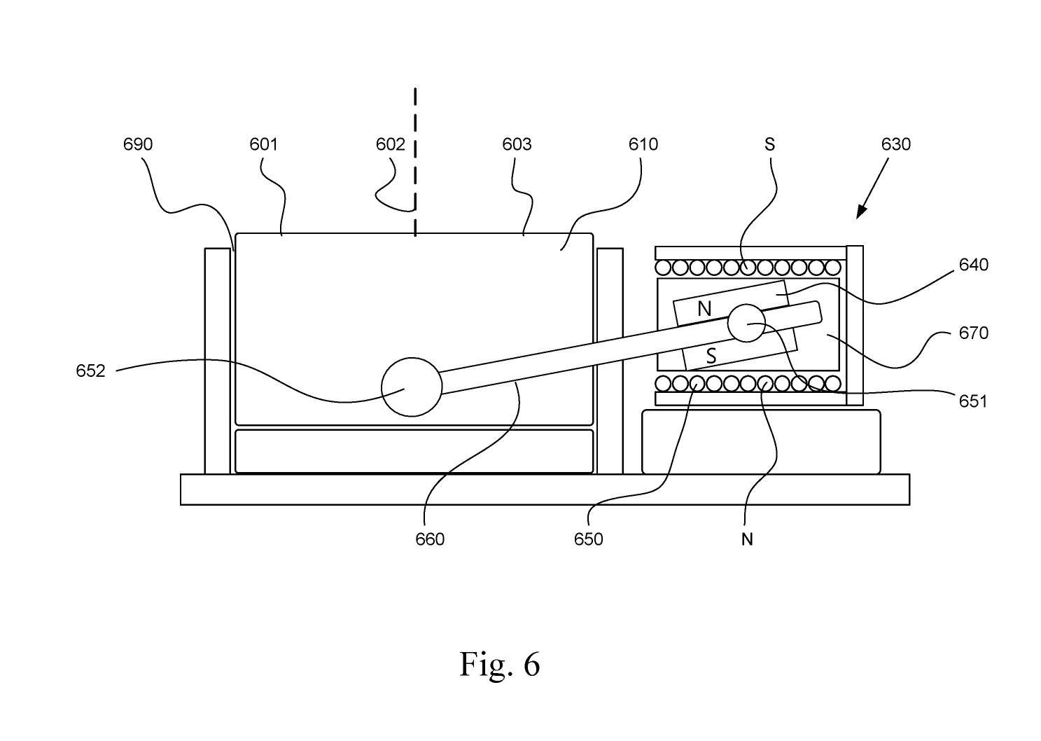

FIG. 6 shows one embodiment of an actuator for moving the retractable lens. The first lens group 601 resides on the optical axis 602 with the at least one lens group actuator 603. The aforementioned structure is shown as a retractable lens 610, wherein the components are mounted to the movable structure. Various alternatives for a retractable lens 610 may be implemented, such as different lens group actuators in the structure or various guide rail configurations. The actuator that is configured to move the retractable lens structure between the active position and the inactive position is referred to as an activating actuator 630.

The activating actuator 630 comprises at least one ferromagnetic element 640. The ferromagnetic element 640 is a permanent magnet. In this embodiment the ferromagnetic element has poles (N, S) aligned to generate a magnetic field. The activating actuator 630 comprises at least one electromagnetic element 650, having poles aligned to generate a magnetic field as a response to an electric current passing though the electromagnetic element 650. The direction of the electric current defines the direction of the magnetic field for the electromagnetic element 650. In the configuration of the present embodiment the magnetic field may be defined in two opposite directions. The electric current passing through the electromagnetic element 650 in the first direction causes the retractable lens 610 to move between the active position and the inactive position. In an embodiment the retractable element 610 moves from the inactive position to the active position as a response to the current passing through the electromagnetic element 650 in the first direction. In an embodiment the retractable lens 610 moves from the active position to the inactive position as a response to the current passing through the electromagnetic element 650 in the second direction. In an embodiment the user may push the retractable lens 610 back into the inactive position.

In an embodiment the activating actuator 630 comprises a connecting arm 660 having a first pivot 651 around which the connecting 660 arm is configured to rotate, a second pivot 652 being attached to the retractable lens 610. The ferromagnetic element 640 is attached to the connecting arm 660. The electromagnetic element 650 is configured around the portion of the connecting arm 660 having the ferromagnetic element 640. The electromagnetic element 650 has a magnetic field having poles on the opposite sides of the ferromagnetic element. The opposite poles attract each other, causing rotation in the activating actuator 630.

In one embodiment the electric current passing through the electromagnetic element 650 in the first direction causes the magnetic field of the electromagnetic element 650 to rotate the ferromagnetic element 640 inside the electromagnetic element 650, further causing the connecting arm 660 to rotate around the first pivot 651.

In an embodiment the device comprise a ferromagnetic stopper 670 configured to compress against the ferromagnetic element 640, wherein the rotating movement of the ferromagnetic stopper 670 is hindered, causing friction in the movement of the ferromagnetic element 640 and the connecting arm 660. In an embodiment the ferromagnetic stopper is configured to cause a free-stop to the connecting arm, retaining the retractable lens either in the active or the inactive position. The ferromagnetic stopper may be loosely mounted in connection to the activating actuator 630.

In an embodiment the device comprises a ferromagnetic stopper 670 near the end of the ferromagnetic element's 640 moving range. The ferromagnetic stopper 670 may be a permanent magnet or magnetically soft material that does not stay magnetized. The ferromagnetic stopper 670 interacts with the magnetic field of the ferromagnetic element 640. The ferromagnetic element 640 attracts the ferromagnetic stopper 670 and stabilizes the connecting arm 660 at the end of its moving range. The moving range may be defined as the distance between the inactive and active positions. In an embodiment the magnetic force applied by the electromagnetic element 650 is configured to overcome the force between the ferromagnetic stopper 670 and the ferromagnetic element 640. In one embodiment the friction caused by the ferromagnetic stopper 670 is sufficient to seize the movement of the retractable lens 610. The ferromagnetic stopper may be loosely positioned, allowing some movement in the direction of the first pivot 651 axis, while maintaining the position in relation to the rotation.

In an embodiment the device comprises a guide rail 690 for guiding the retractable lens 610 between the active position and the inactive position. The guide rail 690 may be implemented in the device body in to the activating actuator body. The guide rail 690 allows that the orientation of the retractable lens 610 is maintained and that the motion between the active and the inactive position follows the optical axis 602.

In an embodiment the ferromagnetic stopper 770 is configured to retain the retractable lens 610 either in the active or the inactive position. For example, the retractable lens 610 may be in the fully protruded active position only when the user is taking a picture. This may be achieved by passing a current through the electromagnetic element 650. At other times the retractable lens 610 may be in the inactive position.

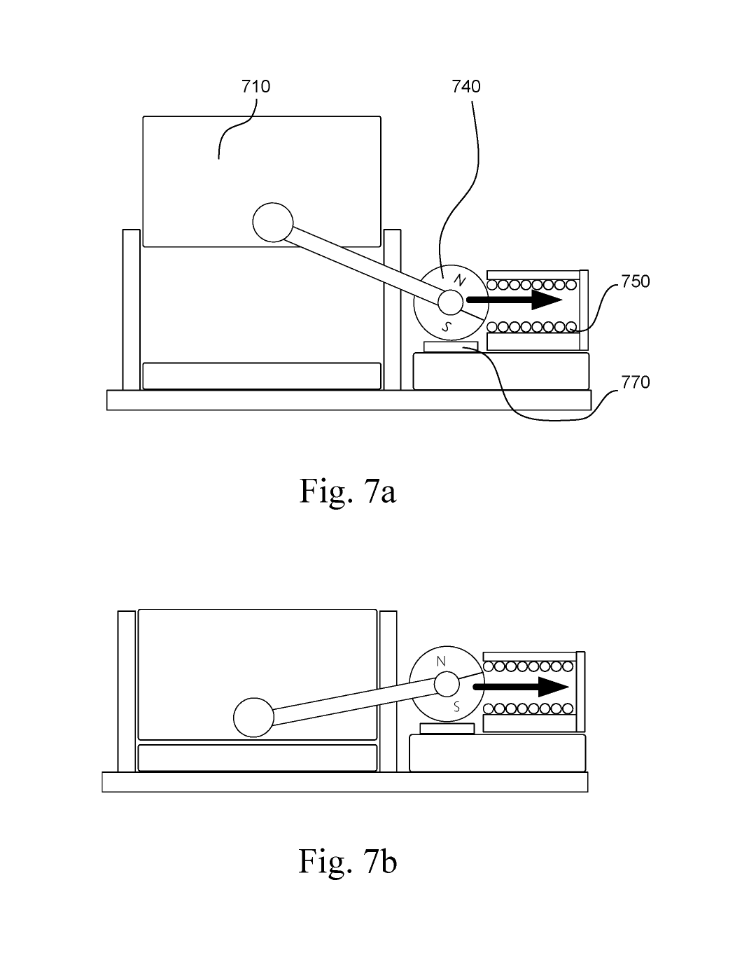

FIG. 7a shows an embodiment having the retractable lens 710 in the active position. The ferromagnetic element 740 has a cylindrical shape. The ferromagnetic stopper 770 is positioned below the ferromagnetic element, causing friction at the cylindrical wall of the ferromagnetic element 740. The electromagnetic element 750 is positioned parallel to the ferromagnetic element 740, wherein the second magnetic field caused by the electromagnetic element 760 may be directed to affect the first magnetic field of the ferromagnetic element 740. FIG. 7b shows the embodiment in the inactive position.

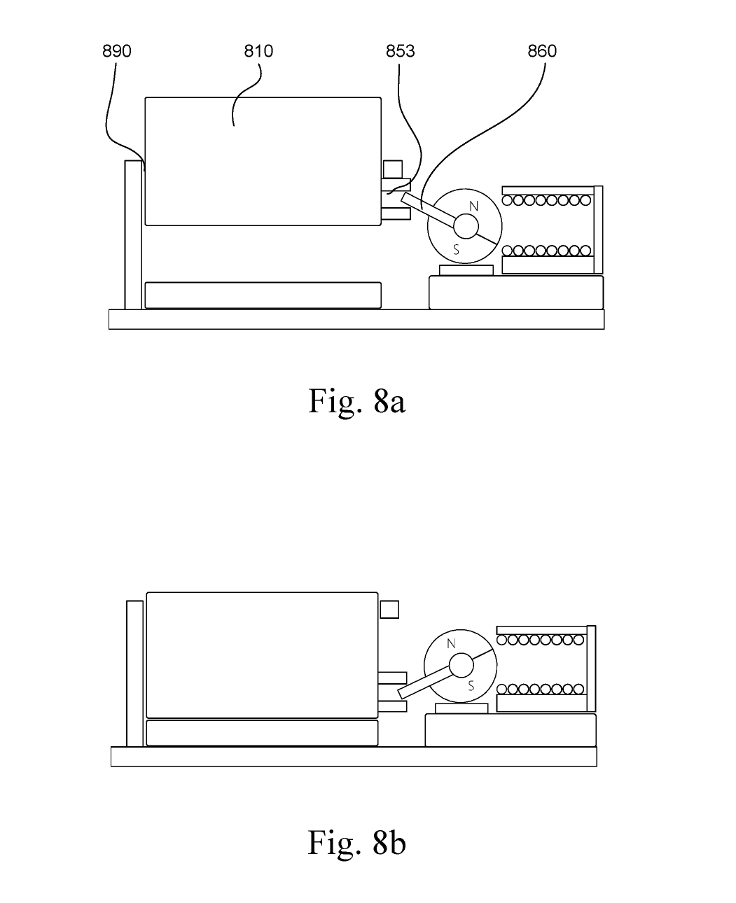

FIG. 8a and FIG. 8b show an embodiment where the second pivot is a yoke 853 configured in the retractable lens 810. The connecting arm 860 is in contact with the yoke 853 of the retractable lens 810 from one side only. The retractable lens may be configured to slide along a guide rail 890.

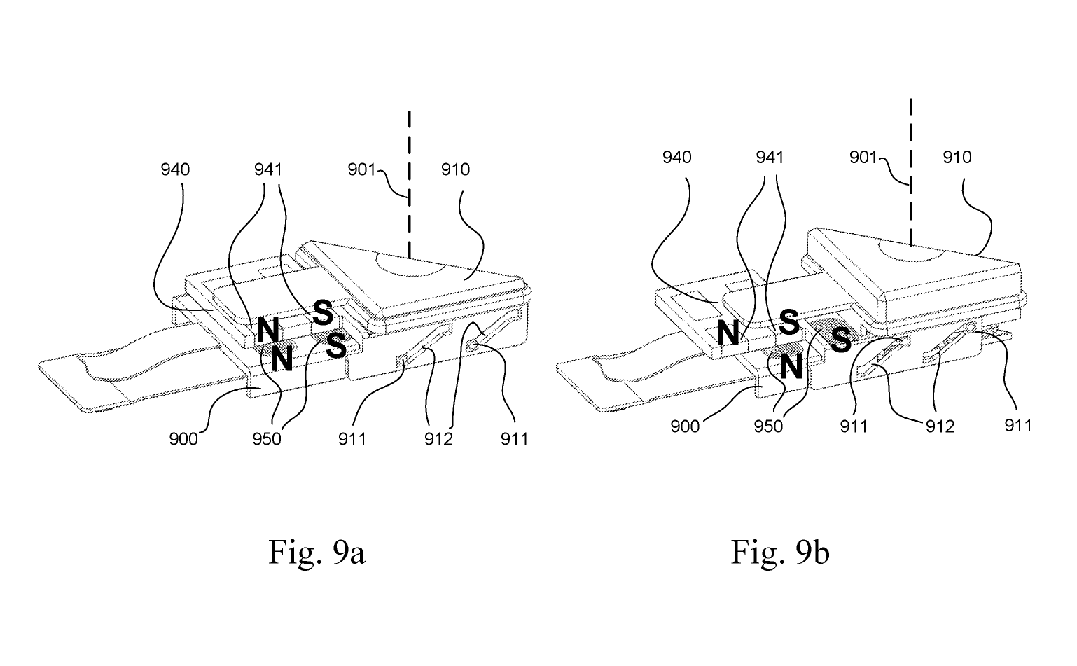

FIG. 9a and FIG. 9b show an embodiment wherein the activating actuator comprises a slider for moving the retractable lens 810 vertically along the optical axis 801. The slider 840 is configured to move laterally, for example inside the device body. The slider 840 comprises at least one slot 841 at an oblique angle in relation to the lateral movement of the slider. The retractable lens 810 comprises at least one lens support pin 811. The lens support pin 811 is configured to support the retractable lens 810. The lens support pin 811 is fitted inside the slot 841, wherein the lateral movement of the slider 840 transforms into the vertical movement of the retractable lens 810. The retractable lens is configured to move along a guide rail 890, maintaining the vertical movement along the optical axis 801. The lateral movement of the slider 840 causes the retractable lens 810 to move between the active position and the inactive position.

In an embodiment the activating actuator comprises at least one ferromagnetic element 841 having poles aligned to generate a first magnetic field, wherein the ferromagnetic element 841 is attached to the slider 840. The activating actuator comprises at least one electromagnetic element 850 having poles aligned to generate a second magnetic field as a response to an electric current passing though the electromagnetic element 850, wherein the electromagnetic element 850 is attached to an actuator body 800. The electric current passing through the electromagnetic element 850 in the first direction causes the second magnetic field to interact with the first magnetic field and to move the slider 840, causing the retractable lens to move from the inactive position to the active position.

Using the smartphone as an example, a 2-3 mm vertical movement may be generated using a dual-pair moving magnet system configured to move a slider horizontally by 4-5 mm. The electromagnetic element initiates the movement with a similar polarization as permanent magnets. As the motion continues, one of the moving magnets catches the coil with an opposite polarization and finalizes the movement, thereby extending the resulted stroke to the functional limit. The slider operates a lifting track configured to move the lens supporting pins attached to the moving upper camera block.

The actuator structure may be integrated around the camera module shape. The electric coils in the electromagnetic elements may remain static most of the time and can be provided with a flexible printed circuit. The self-locking function may be enabled in the active and inactive positions. The solution does not provide additional sounds compared to the conventional systems, while providing a fast actuating action.

The slot stack for the pin may provide an exact and stable vertical movement upwards for the camera block without tilting issues. With the slider solution the magnets on the slider arm are kept away from the sensitive camera block when activating the pop-up mode. There will be less interference on the autofocus or optical image stabilization. The retractable lens structure utilizes the available space around the image sensor group. In this context a difference of the imaging device's size in the scale of 0.01 mm may be considered an improvement. The reduced size of a single component may have an effect on other components in the electronic device, for example on how the other components are positioned inside the device.

A device is disclosed, comprising: a retractable lens having a first lens group on an optical axis; at least one lens group actuator configured to move the first lens group; and an activating actuator configured to move the retractable lens along the optical axis between an active position and an inactive position, wherein: the activating actuator comprises at least one ferromagnetic element having poles aligned to generate a magnetic field and at least one electromagnetic element having poles aligned to generate a magnetic field as a response to an electric current passing though the electromagnetic element; and the electric current passing through the electromagnetic element in the first direction causes the retractable lens to move between the active position and the inactive position. In an embodiment the activating actuator comprises a connecting arm having a first pivot around which the connecting arm is configured to rotate, a second pivot being attached to the retractable lens, the ferromagnetic element being attached to the connecting arm, the electromagnetic element configured around the portion of the connecting arm having the ferromagnetic element, wherein the electromagnetic element has a magnetic field having poles on the opposite sides of the ferromagnetic element. In an embodiment the electric current passing through the electromagnetic element in the first direction causes the magnetic field of the electromagnetic element to rotate the ferromagnetic element inside the electromagnetic element, further causing the connecting arm to rotate around the first pivot. In an embodiment the device comprises a ferromagnetic stopper configured to compress against the ferromagnetic element, wherein the rotating movement of the ferromagnetic stopper is hindered, causing friction in the movement of the ferromagnetic element and the connecting arm. In an embodiment the ferromagnetic stopper is configured to cause a free-stop to the connecting arm, retaining the retractable lens either at the active or the inactive position. In an embodiment the device comprises a ferromagnetic stopper near the end of the ferromagnetic element's moving range, causing the magnetic field of the ferromagnetic element to attract the ferromagnetic stopper and stabilizing the connecting arm at the end of the moving range, wherein the magnetic force applied by the electromagnetic element is configured to overcome the force between the ferromagnetic stopper and the ferromagnetic element. In an embodiment the device comprises a device, comprising a guide rail configured to guide the retractable lens between the active position and the inactive position.

An actuator is disclosed, comprising: a connecting arm having a first pivot around which the connecting arm is configured to rotate and a second pivot configured to attach the connecting arm to a retractable lens, wherein the connecting arm is configured to move the retractable lens along the optical axis between an active position and an inactive position; at least one ferromagnetic element having poles aligned to generate a first magnetic field, wherein the ferromagnetic element is attached to the connecting arm; at least one electromagnetic element having poles aligned to generate a second magnetic field as a response to an electric current passing though the electromagnetic element, wherein the electromagnetic element is attached to an actuator body; and the electric current passing through the electromagnetic element in the first direction causes the second magnetic field to interact with the first magnetic field and the connecting arm to move the retractable lens from the inactive position to the active position. In an embodiment the second pivot is in a slot configured to the retractable lens. In an embodiment the ferromagnetic element comprises a cylindrical shape. In an embodiment the electromagnetic element is parallel to the ferromagnetic element. In an embodiment the actuator comprises a ferromagnetic stopper configured to compress against the ferromagnetic element, wherein the rotating movement of the ferromagnetic stopper is hindered, causing friction in the movement of the ferromagnetic element and the connecting arm. In an embodiment the ferromagnetic stopper is configured to retain the retractable lens either in the active or the inactive position. In an embodiment the actuator comprises a ferromagnetic stopper near the end of the ferromagnetic element's moving range, causing the magnetic field of the ferromagnetic element to attract the ferromagnetic stopper and stabilizing the connecting arm at the end of the moving range, wherein the magnetic force applied by the electromagnetic element is configured to overcome the force between the ferromagnetic stopper and the ferromagnetic element. In an embodiment the actuator comprises a guide rail configured to guide the retractable lens between the active position and the inactive position.

An actuator is disclosed, comprising a slider configured to move laterally; a retractable lens configured to move vertically along an optical axis between an active position and an inactive position, comprising a lens support pin; the slider comprising a slot at an oblique angle in relation to the lateral movement, wherein the lens support pin is configured to slide inside the slot and the lateral movement of the slider causes the retractable lens to move between the active position and the inactive position; at least one ferromagnetic element having poles aligned to generate a first magnetic field, wherein the ferromagnetic element is attached to the slider; at least one electromagnetic element having poles aligned to generate a second magnetic field as a response to an electric current passing though the electromagnetic element, wherein the electromagnetic element is attached to an actuator body; and the electric current passing through the electromagnetic element in the first direction causes the second magnetic field to interact with the first magnetic field and to move the slider, causing the retractable lens to move from the inactive position to the active position. In an embodiment the actuator comprises a ferromagnetic stopper configured to compress against the ferromagnetic element, wherein the movement of the ferromagnetic stopper is hindered, causing friction in the movement of the ferromagnetic element. In an embodiment the ferromagnetic stopper is configured to retain the retractable lens either in the active or the inactive position. In an embodiment the actuator comprises a ferromagnetic stopper near the end of the ferromagnetic element's moving range, causing the magnetic field of the ferromagnetic element to attract the ferromagnetic stopper and stabilizing the slider at the end of the moving range, wherein the magnetic force applied by the electromagnetic element is configured to overcome the force between the ferromagnetic stopper and the ferromagnetic element. In an embodiment the actuator comprises a guide rail configured to guide the retractable lens between the active position and the inactive position.

An example of the apparatus or a system described hereinbefore is a computing-based device comprising one or more processors which may be microprocessors, controllers or any other suitable type of processors for processing computer executable instructions to control the operation of the device in order to control one or more sensors, receive sensor data and use the sensor data. Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as memory and communications media. Computer storage media, such as memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device it will be appreciated that the storage may be distributed or located remotely and accessed via a network or other communication link, for example by using communication interface.

The computing-based device may comprise an input/output controller arranged to output display information to a display device which may be separate from or integral to the computing-based device. The display information may provide a graphical user interface, for example, to display hand gestures tracked by the device using the sensor input or for other display purposes. The input/output controller is also arranged to receive and process input from one or more devices, such as a user input device (e.g. a mouse, keyboard, camera, microphone or other sensor). In some embodiments the user input device may detect voice input, user gestures or other user actions and may provide a natural user interface (NUI). This user input may be used to configure the device for a particular user such as by receiving information about bone lengths of the user. In an embodiment the display device may also act as the user input device if it is a touch sensitive display device. The input/output controller may also output data to devices other than the display device, e.g. a locally connected printing device.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

Any range or device value given herein may be extended or altered without losing the effect sought.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments or a combination thereof. The embodiments are not limited to those that solve any or all of the stated problems or those that have any or all of the stated benefits and advantages. It will further be understood that reference to ‘an’ item refers to one or more of those items.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to or combinations of the disclosed embodiments without departing from the spirit or scope of this specification.

1. A device, comprising:
a retractable lens having a first lens group on an optical axis;
at least one lens group actuator configured to move the first lens group; and
an activating actuator configured to move the retractable lens along the optical axis between an active position and an inactive position, wherein:
the activating actuator comprises at least one ferromagnetic element having poles aligned to generate a magnetic field and at least one electromagnetic element having poles aligned to generate a magnetic field as a response to an electric current passing though the electromagnetic element; and
the electric current passing through the electromagnetic element in the first direction causes the retractable lens to move between the active position and the inactive position.

2. A device according to claim 1, wherein the activating actuator comprises a connecting arm having a first pivot around which the connecting arm is configured to rotate, a second pivot being attached to the retractable lens, the ferromagnetic element being attached to the connecting arm, the electromagnetic element configured around the portion of the connecting arm having the ferromagnetic element, wherein the electromagnetic element has a magnetic field having poles on the opposite sides of the ferromagnetic element.

3. A device according to claim 2, wherein the electric current passing through the electromagnetic element in the first direction causes the magnetic field of the electromagnetic element to rotate the ferromagnetic element inside the electromagnetic element, further causing the connecting arm to rotate around the first pivot.

4. A device according to claim 1, comprising a ferromagnetic stopper configured to compress against the ferromagnetic element, wherein the rotating movement of the ferromagnetic stopper is hindered, causing friction in the movement of the ferromagnetic element and the connecting arm.

5. A device according to claim 4, wherein the ferromagnetic stopper is configured to cause a free-stop to the connecting arm, retaining the retractable lens either in the active or the inactive position.

6. A device according to claim 1, comprising a ferromagnetic stopper near the end of the ferromagnetic element's moving range, causing the magnetic field of the ferromagnetic element to attract the ferromagnetic stopper and stabilizing the connecting arm at the end of the moving range, wherein the magnetic force applied by the electromagnetic element is configured to overcome the force between the ferromagnetic stopper and the ferromagnetic element.

7. A device according to claim 1, comprising a guide rail configured to guide the retractable lens between the active position and the inactive position.

8. An actuator, comprising:
a connecting arm having a first pivot around which the connecting arm is configured to rotate and a second pivot configured to attach the connecting arm to a retractable lens, wherein the connecting arm is configured to move the retractable lens along the optical axis between an active position and an inactive position;
at least one ferromagnetic element having poles aligned to generate a first magnetic field, wherein the ferromagnetic element is attached to the connecting arm;
at least one electromagnetic element having poles aligned to generate a second magnetic field as a response to an electric current passing though the electromagnetic element, wherein the electromagnetic element is attached to an actuator body; and
the electric current passing through the electromagnetic element in the first direction causes the second magnetic field to interact with the first magnetic field and the connecting arm to move the retractable lens from the inactive position to the active position.

9. An actuator according to claim 8, wherein the second pivot is in a slot configured to the retractable lens.

10. An actuator according to claim 8, wherein the ferromagnetic element comprises a cylindrical shape.

11. An actuator according to claim 8, wherein the electromagnetic element is parallel to the ferromagnetic element.

12. An actuator according to claim 8, comprising a ferromagnetic stopper configured to compress against the ferromagnetic element, wherein the rotating movement of the ferromagnetic stopper is hindered, causing friction in the movement of the ferromagnetic element and the connecting arm.

13. An actuator according to claim 12, wherein the ferromagnetic stopper is configured to retain the retractable lens either in the active or the inactive position.

14. An actuator according to claim 8, comprising a ferromagnetic stopper near the end of the ferromagnetic element's moving range, causing the magnetic field of the ferromagnetic element to attract the ferromagnetic stopper and stabilizing the connecting arm at the end of the moving range, wherein the magnetic force applied by the electromagnetic element is configured to overcome the force between the ferromagnetic stopper and the ferromagnetic element.

15. An actuator according to claim 8, comprising a guide rail configured to guide the retractable lens between the active position and the inactive position.

16. An actuator, comprising
a slider configured to move laterally;
a retractable lens configured to move vertically along an optical axis between an active position and an inactive position, comprising a lens support pin;
the slider comprising a slot at an oblique angle in relation to the lateral movement, wherein the lens support pin is configured to slide inside the slot and the lateral movement of the slider causes the retractable lens to move between the active position and the inactive position;
at least one ferromagnetic element having poles aligned to generate a first magnetic field, wherein the ferromagnetic element is attached to the slider;
at least one electromagnetic element having poles aligned to generate a second magnetic field as a response to an electric current passing though the electromagnetic element, wherein the electromagnetic element is attached to an actuator body; and
the electric current passing through the electromagnetic element in the first direction causes the second magnetic field to interact with the first magnetic field and to move the slider, causing the retractable lens to move from the inactive position to the active position.

17. An actuator according to claim 16, comprising a ferromagnetic stopper configured to compress against the ferromagnetic element, wherein the movement of the ferromagnetic stopper is hindered, causing friction in the movement of the ferromagnetic element and the connecting arm.

18. An actuator according to claim 17, wherein the ferromagnetic stopper is configured to retain the retractable lens either in the active or the inactive position.

19. An actuator according to claim 16, comprising a ferromagnetic stopper near the end of the ferromagnetic element's moving range, causing the magnetic field of the ferromagnetic element to attract the ferromagnetic stopper and stabilizing the connecting arm at the end of the moving range, wherein the magnetic force applied by the electromagnetic element is configured to overcome the force between the ferromagnetic stopper and the ferromagnetic element.

20. An actuator according to claim 16, comprising a guide rail configured to guide the retractable lens between the active position and the inactive position.
